(19) United States
(12) Patent Application Publication
(10) Pub. No.: US 2018/0144180 A1
(43) Pub. Date: May 24, 2018

(54) FINGERPRINT IDENTIFICATION MODULE

(71) Applicant: KEYCORE TECHNOLOGY CORP., Zhubei City (TW)

(72) Inventors: Wei-Cheng Lin, Zhubei City (TW); Chien-Jen Hsiao, Zhubei City (TW); Shih-Hsiu Tseng, Zhubei City (TW)

(21) Appl. No.: 15/355,076

(22) Filed: Nov. 18, 2016

(51) Int. Cl. G06K 9/00

(52) U.S. Cl. CPC G06K 9/00087; G06K 9/00013

(57) ABSTRACT

A fingerprint identification module includes a substrate and multiple fingerprint sensation units. The substrate has a first face and a second face. The fingerprint sensation units are disposed on the second face of the substrate. Each fingerprint sensation unit has a substrate layer. The substrate layer has a first surface, a second surface, a sensation layer and a control IC. The sensation layer is disposed on the first surface. The control IC is selectively disposed on the first surface or the second surface. The fingerprint identification module improves the shortcomings that it is uneasy to manufacture large-scale palm print identification module and the manufacturing cost of the large-scale palm print identification module is too high.

### BACKGROUND OF THE INVENTION

1. Field of the Invention

The present invention relates generally to a fingerprint identification module, and more particularly to a fingerprint identification module, which is able to lower the manufacturing cost of the large-scale fingerprint or palm print identification module.

2. Description of the Related Art

The current mobile device such as a mobile phone or a tablet is equipped with a fingerprint identification module. The fingerprint identification module not only serves to provide security identification for use of the mobile phone, but also serves as a mobile security checking system for the payment of a third party. The conventional fingerprint identification module is mainly disposed on a non-touch section of the mobile device. That is, the fingerprint identification zone and the touch section are separated from each other. Moreover, the conventional fingerprint identification module can perform fingerprint identification work on a small local area one at a time. In the case that there is more than one fingerprint needing identification, the fingerprints cannot be identified at one time and must be identified one by one. At the current stage, the palm print identification module has a larger identification range. Therefore, in manufacturing of the palm print identification module, it is necessary to enlarge the identification zone. The manufacturing cost of the fingerprint or palm print identification module with large-range fingerprint or palm print identification zone is very high. In addition, the defect-free rate of the palm print identification module is relatively low. It is therefore tried by the applicant to provide a fingerprint identification module, which is manufactured at lower cost and high defect-free rate to solve the problem of the conventional fingerprint identification module.

### SUMMARY OF THE INVENTION

It is therefore a primary object of the present invention to provide a fingerprint identification module, which is able to lower the manufacturing cost of large-scale fingerprint or palm print identification module.

It is a further object of the present invention to provide a fingerprint identification module, which is able to increase defect-free rate in manufacturing of large-scale fingerprint or palm print identification module.

To achieve the above and other objects, the fingerprint identification module of the present invention includes a substrate and multiple fingerprint sensation units.

The substrate has a first face and a second face. The first and second faces are correspondingly positioned on upper and lower sides of the substrate.

The fingerprint sensation units are disposed on the second face of the substrate. Each fingerprint sensation unit has a substrate layer. The substrate layer has a first surface, a second surface, a sensation layer and a control IC. The sensation layer is disposed on the first surface. The control IC is selectively disposed on the first surface or the second surface. The fingerprint identification module of the present invention is able to solve the problem of the conventional fingerprint identification module that manufacturing cost is too high and the defect-free rate is too low.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective exploded view of a first embodiment of the fingerprint identification module of the present invention;

FIG. 2 is a side assembled view of the first embodiment of the fingerprint identification module of the present invention;

FIG. 3 is a side assembled view of a second embodiment of the fingerprint identification module of the present invention;

FIG. 4 is a side assembled view of a third embodiment of the fingerprint identification module of the present invention;

FIG. 5 is a side assembled view of a fourth embodiment of the fingerprint identification module of the present invention; and

FIG. 6 is a schematic diagram showing the use of the fingerprint identification module of the present invention.

### DETAILED DESCRIPTION OF THE PREFERRED EMBODIMENTS

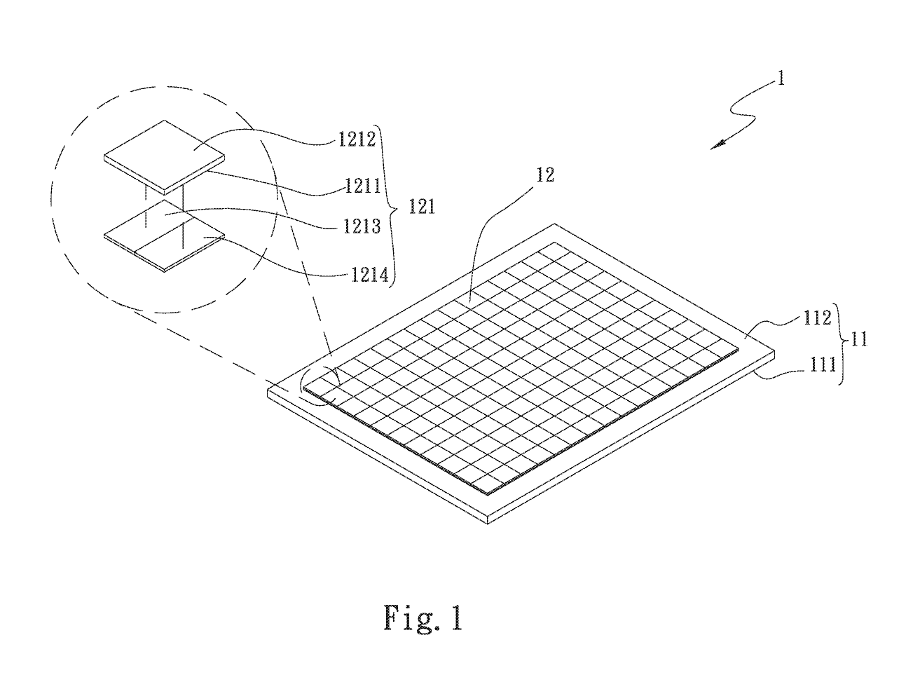

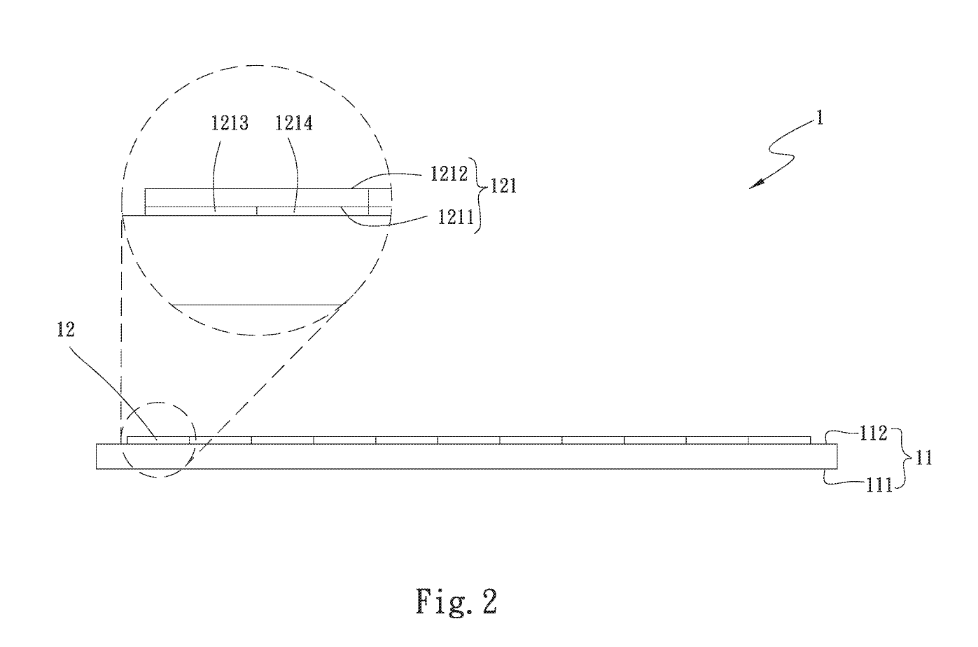

Please refer to FIGS. 1 and 2. FIG. 1 is a perspective exploded view of a first embodiment of the fingerprint identification module of the present invention. FIG. 2 is a side assembled view of the first embodiment of the fingerprint identification module of the present invention. According to the first embodiment, the fingerprint identification module 1 of the present invention includes a substrate 1 and multiple fingerprint sensation units 12.

The substrate 11 has a first face 111 and a second face 112. The first and second faces 111, 112 are correspondingly positioned on upper and lower sides of the substrate 11. The substrate 11 is made of glass material or polymethyl methacrylate. In this embodiment, the substrate 11 is made of, but not limited to, glass material for illustration purposes.

The fingerprint sensation units 12 are disposed on the second face 112 of the substrate 11 and arranged side by side in immediate adjacency to each other. Each fingerprint sensation unit 12 has a substrate layer 121, which is a silicon substrate.

The substrate layer 121 has a first surface 1211, a second surface 1212, a sensation layer 1213 and a control IC 1214. The sensation layer 1213 is disposed on the first surface 1211. The control IC 1214 is disposed on the first surface 1211 in adjacency to the sensation layer 1213. The sensation layer 1213 has multiple sensation electrodes and multiple wires (not shown). The sensation electrodes and the wires are electrically connected to the control IC. The layered structure of the sensation layer 1213 pertains to the wiring structure of the conventional fingerprint identification device and thus will not be redundantly described hereinafter.

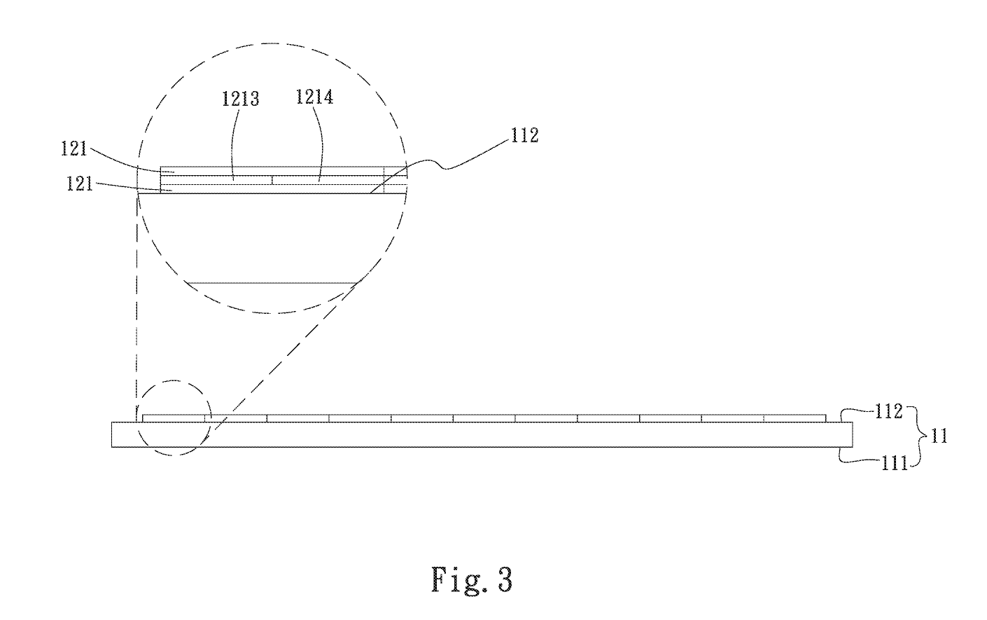

Please now refer to FIG. 3, which is a side assembled view of a second embodiment of the fingerprint identification module of the present invention. The second embodiment is partially identical to the first embodiment in structure and thus will not be repeatedly described hereinafter. The second embodiment is different from the first embodiment in that the substrate layer 121 is a silicon dioxide film. With the silicon dioxide film as the substrate layer 121, it is necessary to layer-by-layer form the structure layers of the fingerprint sensation unit 12 on the second face 112 of the substrate 11 by means of coating. First, the silicon dioxide film is coated on the second face 112 of the substrate 11 to enhance the adherence. Then, the sensation layer 1213 and the control IC 1214 of the fingerprint sensation unit 12 are disposed on the silicon dioxide film previously coated on the second face 112 of the substrate 11. Then, a layer of silicon dioxide film is further coated on the sensation layer 1213 and the control IC 1214 to form the substrate layer 121 of the fingerprint sensation unit 12 for insulation.

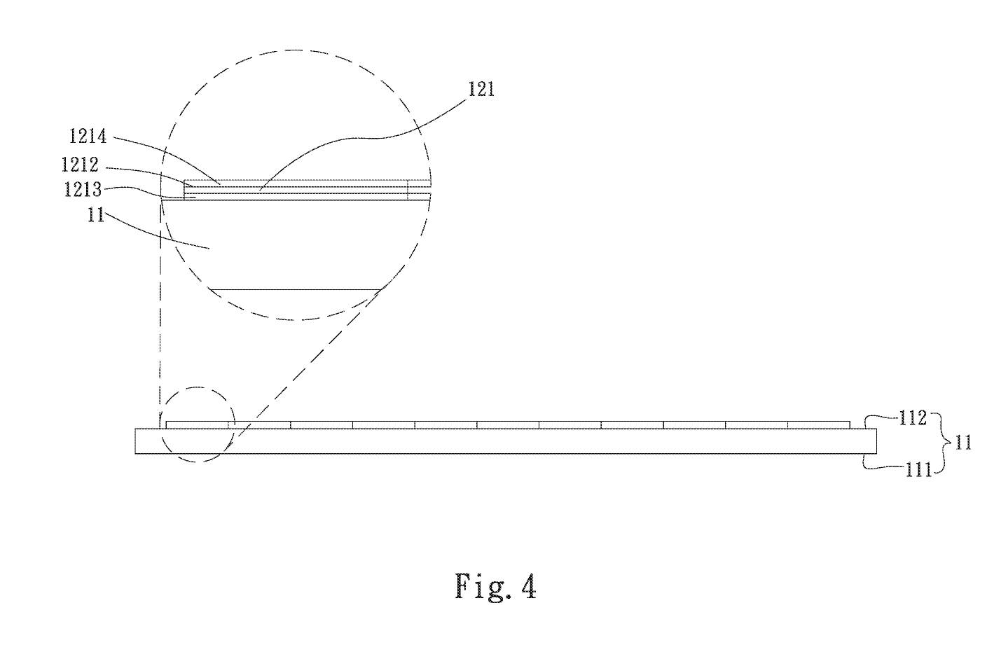

Please now refer to FIG. 4, which is a side assembled view of a third embodiment of the fingerprint identification module of the present invention. The third embodiment is partially identical to the first embodiment in structure and thus will not be repeatedly described hereinafter. The third embodiment is different from the first embodiment in that the control IC 1214 is disposed on the second surface 1212. That is, the control IC 1214 and the sensation layer 1213 are oppositely disposed on the upper and lower sides of the substrate layer 121.

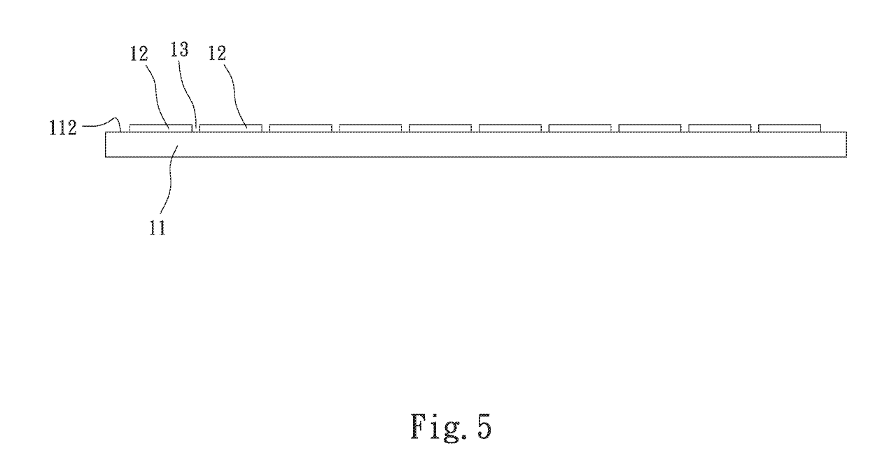

Please now refer to FIG. 5, which is a side assembled view of a fourth embodiment of the fingerprint identification module of the present invention. The fourth embodiment is partially identical to the first embodiment in structure and thus will not be repeatedly described hereinafter. The fourth embodiment is different from the first embodiment in that the fingerprint sensation units 12 are arranged on the second face 112 of the substrate 11 at intervals. A gap 13 is defined between each two adjacent fingerprint sensation units 12. By means of a calculation method, the identification void section caused by the gap 13 can be eliminated. The calculation method pertains to a conventional error correction calculation method and thus will not be redundantly described hereinafter.

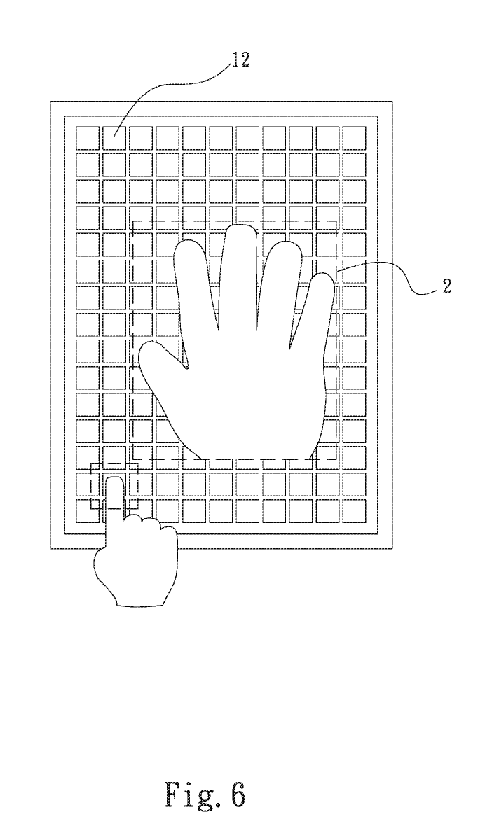

Please now refer to FIG. 6, which is a schematic diagram showing the use of the fingerprint identification module of the present invention. Also referring to FIGS. 1-5, multiple fingerprint sensation units 12 are disposed on the second face 112 of the substrate 11 of the fingerprint identification module 1. The fingerprint sensation units 12 are arranged in an array as a palm print identification zone 2. When a user needs fingerprint identification, the fingerprint sensation unit 12 can solely perform fingerprint identification operation. In the case that a large-area palm print identification is required or multiple fingerprints need to be identified at the same time, the palm print identification zone 2 is used to perform the identification operation. The fingerprint sensation units 12 are disposed on the second face 112 of the substrate 11 of the fingerprint identification module 1 of the present invention. However, in practical operation, the fingerprint identification of a user is performed on the first face 111 of the substrate 11.

It is a primary object of the present invention to improve the manufacturing shortcoming of the conventional fingerprint or palm print identification module with large-scale fingerprint or palm print identification zone. In fingerprint identification module of the present invention, multiple fingerprint sensation units are arranged in an array as a large-area fingerprint or palm print identification zone. This can lower the manufacturing cost. The manufacturing of the conventional large-scale fingerprint identification module necessitates a large-scale silicon substrate material so that the cost is relatively high. In addition, a defective product is easy to produce in the manufacturing process to increase the defect rate. By means of the fingerprint identification module 1 of the present invention, the manufacturing cost of the fingerprint identification module is lowered and the defect rate is reduced to improve the shortcoming of the conventional fingerprint identification module.

The present invention has been described with the above embodiments thereof and it is understood that many changes and modifications in such as the form or layout pattern or practicing step of the above embodiments can be carried out without departing from the scope and the spirit of the invention that is intended to be limited only by the appended claims.

1. A fingerprint identification module comprising:
a substrate having a first face and a second face, the first and second faces being correspondingly positioned on upper and lower sides of the substrate; and
multiple fingerprint sensation units disposed on the second face of the substrate, each fingerprint sensation unit having a substrate layer, the substrate layer having a first surface, a second surface, a sensation layer and a control IC, the sensation layer being disposed on the first surface, the control IC being selectively disposed on the first surface or the second surface;
wherein the substrate layer is a silicon dioxide film, and by means of layer-by-layer coating, structure layers of the fingerprint sensation unit are formed on the second face of the substrate.

2. (canceled)

3. The fingerprint identification module as claimed in claim 1, wherein the fingerprint sensation units are horizontally arranged at intervals.

4. The fingerprint identification module as claimed in claim 1, wherein the sensation layer has multiple sensation electrodes and multiple wires, the sensation electrodes and the wires being electrically connected to the control IC.

5. The fingerprint identification module as claimed in claim 1, wherein the substrate is made of glass material or polymethyl methacrylate.

6. The fingerprint identification module as claimed in claim 1, wherein a gap is defined between each two adjacent fingerprint sensation units.
